(19) United States
(12) Patent Application Publication
(10) Pub. No.: US 2007/0086306 A1
(43) Pub. Date: Apr. 19, 2007

(54) Data reading device with a switch locatable anywhere, and related system and method

(76) Inventors: Michael C. Ip, Fremont, CA (US); Yancy Chen, Campbell, CA (US); Ming Hee Wong, Milpitas, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/250,044

(22) Filed: Oct. 13, 2005

(51) Int. Cl. G11B 7/00

(52) U.S. Cl. 369/99

(57) ABSTRACT

An electronic device for reading data from a removable storage medium includes a switch to generate a signal that circuitry of the device receives. The switch is connected to the circuitry and disposed outside a housing of the device. Or, in another embodiment, the switch is connected to a circuit board of the device and disposed in the interior of the device, but not mounted to the circuit board. The circuitry of the device can read data stored on a removable storage medium. The housing protects the circuitry and has a plurality of sides that define an interior in which the circuitry is disposed. With the switch disposed outside the housing, the switch may be located where it will be easier to see and reach. Thus, one can more easily avoid damaging the device when one inserts and removes storage media from the device.

### BACKGROUND

Computer systems typically have a processor that receives and generates data and executes instructions, and have one or more storage devices that are coupled to the processor. The processor typically includes circuitry, such as a central processing unit, for performing various computing functions, such as executing programs to perform specific tasks. The one or more storage devices read data stored on a storage medium to provide the processor data that it needs to execute programs, and may write data to the medium to allow data generated by the processor to be stored for future use. The storage medium may be removable from the storage device to allow one to provide the processor a large amount of data, and thus the one or more storage devices typically include a mechanism for inserting and removing the storage medium.

For example, FIG. 1 shows a storage device 10 that can read data stored on a removable compact disc 13. The device 10 includes a laser (not shown) disposed in the interior 11 that generates and directs light toward the compact disc 13, and a circuit board 12 that has circuitry (not shown) for converting the light reflected from the compact disc 13 into an electrical signal corresponding to the data stored on the compact disc. The device 10 also includes a tray 14 for carrying the compact disc 13 into and out of the interior 11, and a motor (not shown) that moves the tray 14 into and out of the interior 11. The circuitry includes a switch 16 mounted to the circuit board for generating a signal for the motor to move the tray 14. The device 10 also includes a housing 18 and a cover plate 20 to protect the laser, circuitry (including the switch 16), tray 14, and motor. The cover plate 20 is mounted to the housing 18 and includes a button 22 to allow one to operate the switch 16 when the cover plate 20 is mounted to the housing 18. The cover plate 20 also includes an opening 24 that the tray 14 extends through when the motor moves the tray 14 into and out of the interior 11 of the device 10.

To insert the compact disc 13 into the device 10, one pushes the button 22 to close the switch 16. When closed, the switch 16 generates a signal in the circuitry that causes the motor to extend the tray 14 through the opening 24. One then places the compact disc 13 on the tray 14. One then pushes the button 22, again, to cause the switch 16 to generate another signal in the circuitry that causes the motor to retract the tray 14. With the compact disc 13 in the interior 11, the device 10 can read the data stored on the compact disc 13. To remove the compact disc 13 from the device 10, one pushes the button 22 again to cause the motor to extend the tray 14 through the opening 24.

Unfortunately, the location of the switch 16, and thus button 22, makes one's use of the button 22 awkward. The tray 14 is typically located above the switch 16 and button 22. When the tray 14 is extended through the opening 24, the tray 14 typically extends about 5 inches (approximately the diameter of a compact disc). Thus, one typically cannot see the button 22 to push it to retract the tray 14 back through the opening 24. And thus, one has to reach around the tray 14 and feel for the button 22 to retract the tray 14. This can cause one to inadvertently knock the tray 14 and damage it or the motor that moves the tray 14.

A common way to avoid having to reach around the tray 14 and blindly feel for the button 22 is to have the processor of the computer system that is coupled to the device 10 generate a signal to retract or extend the tray 14. But this presents some problems too. For example, because the processor requires a software operating system to function as desired, and the storage device requires a software driver accessible by the operating system, one's ability to extend or retract the tray 14 depends on the operating system and driver functioning properly. If the operating system crashes, the processor would not be able to generate a signal to extend or retract the tray 14 in response to one's input. Also, if the operating system is busy it may take a relatively long time for the processor to generate a signal to extend or retract the tray 14 in response to one's input.

Another common way to avoid having to reach around the tray 14 and blindly feel for the button 22 is to locate the button 22 above the opening 24. But this also presents some problems. Because the switch 16 is mounted to the circuit board 12 and located below the tray 14 when the tray is disposed in the interior 11, a mechanical coupler (not shown) is mounted to the cover plate 20. The coupler mechanically transfers the movement of a button located above the tray 14 to the switch 16 that is located below the tray 14. Unfortunately, the coupler is more apt to bind or wear out because of the additional moving parts. Also, the coupler alters the tactile feel of the switch 16 and thus removes some certainty about closing the switch 16 before the tray 14 moves.

### SUMMARY

In one aspect of the invention, an electronic device for reading data from a removable storage medium includes a switch to generate a signal that circuitry of the device receives. The switch is connected to the circuitry and disposed outside a housing of the device. The circuitry of the device can read data stored on a removable storage medium. The housing protects the circuitry and has a plurality of sides that define an interior in which the circuitry is disposed. With the switch disposed outside the housing, the switch may be located where it will be easier to see and reach. Thus, one can more easily avoid damaging the device when one inserts and removes storage media from the device.

In another aspect of the invention, an electronic device for reading data from a removable storage medium includes a switch to generate a signal that circuitry of the device receives. The switch is connected to a circuit board of the device and disposed in the interior of the device, but not mounted to the circuit board. The circuitry of the device can read data stored on a removable storage medium. The housing protects the circuitry and has a plurality of sides that define an interior in which the circuitry is disposed. With the switch disposed in the interior of the housing but not mounted to the circuit board, the switch may be located where it can be easily contacted by a button mounted on the housing and located where it will be easier to see and reach. Thus, one can more easily avoid damaging the device when one inserts and removes storage media from the device.

### BRIEF DESCRIPTION OF THE FIGURES

FIG. 1 is a perspective view of a conventional storage device.

FIG. 2 is a perspective view of a storage device that includes a switch, according to an embodiment of the invention.

FIG. 3 is a perspective view of the storage device in FIG. 2 that includes a connector for connecting the switch to an interface of the device, according to an embodiment of the invention.

FIG. 4 is a schematic diagram of circuitry included in the device in FIG. 2, according to an embodiment of the invention.

FIG. 5 is a perspective view of a storage device that includes a switch, according to another embodiment of the invention.

FIG. 6 is a perspective view of a storage device that includes a switch, according to yet another embodiment of the invention.

FIG. 7 is a perspective view of a system that includes a storage device, according to an embodiment of the invention.

### DETAILED DESCRIPTION

The following discussion is presented to enable one skilled in the art to make and use the invention. Various modifications to the disclosed embodiments will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

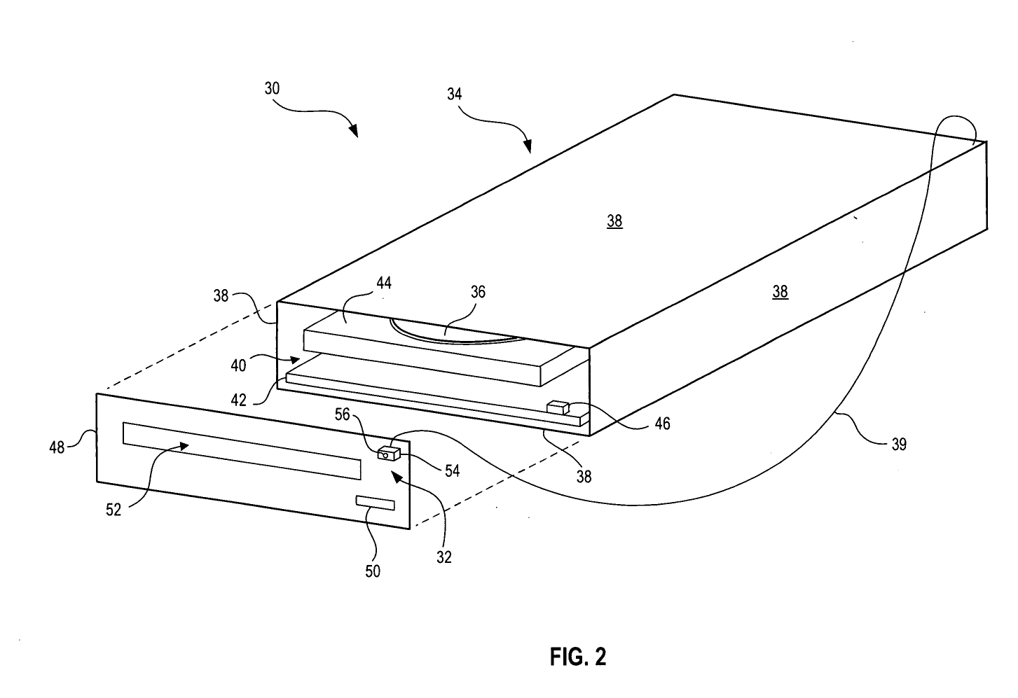

FIG. 2 is a perspective view of a storage device 30 that includes a switch 32 disposed outside a housing 34 of the device 30, according to an embodiment of the invention. The device 30 reads data stored on a removable storage medium, such as a compact disc 36 or a magnetic disc, and may write data onto the medium to store the data for future use. The housing 34 includes walls 38 that define an interior 40. When one exerts pressure on the switch 32, circuitry (not shown) within the device 30 instructs the device to move the compact disc 36 into or out of the interior 40 to allow one to insert or remove the disc 36 from the device 30. The switch 32 may also be used to have the device 30 perform other functions, such as instructing the device 30 to read data stored on the disc 36 when the disc 36 is disposed in the interior 40. With the switch 32 disposed outside the housing 36, the switch 32 may be located where it will be easier to see and reach after the device 30 has moved the compact disc 36 out of the interior 40 of the device 30. Thus, one can more easily avoid damaging the device 30 when one inserts and removes the compact disc 36 from the device 30.

The storage device 30 may be any type of storage device that reads data from a removable storage medium. For example, in one embodiment the device 30 is an optical disc drive that includes a laser (not shown) and a circuit board 42, each disposed in the interior 40. The laser generates and directs light toward the compact disc 36, and the circuit board 42 includes circuitry (not shown) for converting the light reflected from the compact disc 36 into an electrical signal. The device 30 also includes a cable 39 that connects the switch 32 to the circuitry, a tray 44 to carry the compact disc 36 into and out of the interior 40, and a motor (not shown) that moves the tray 44 into and out of the interior 40.

Other embodiments of the device are contemplated. For example, the storage device 30 may be a floppy disk drive that reads data stored on a magnetic disk that is removable from the device 30.

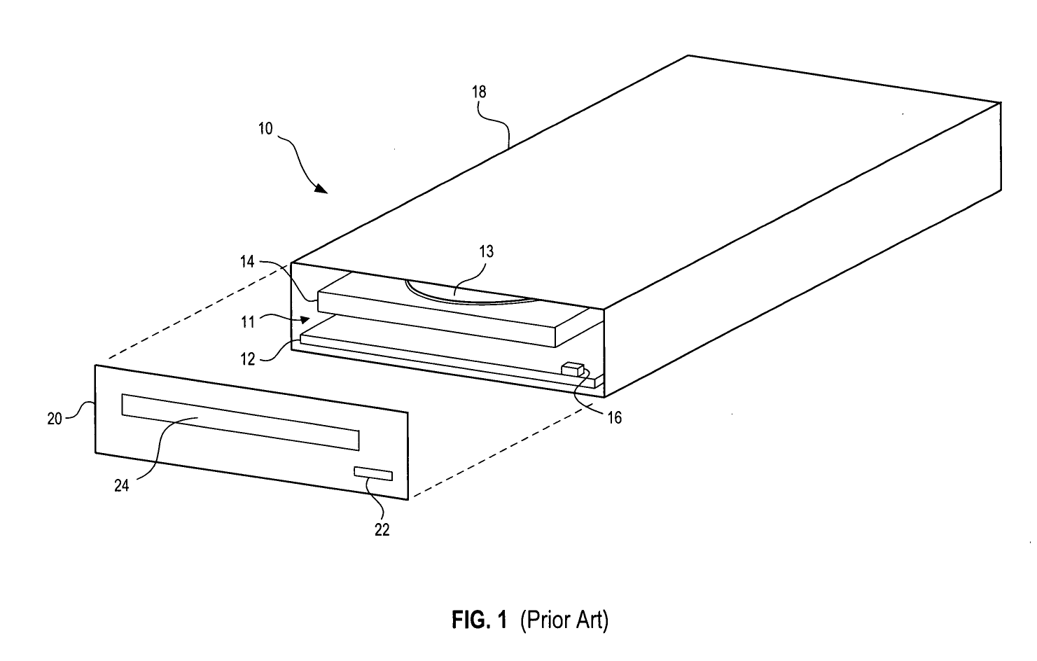

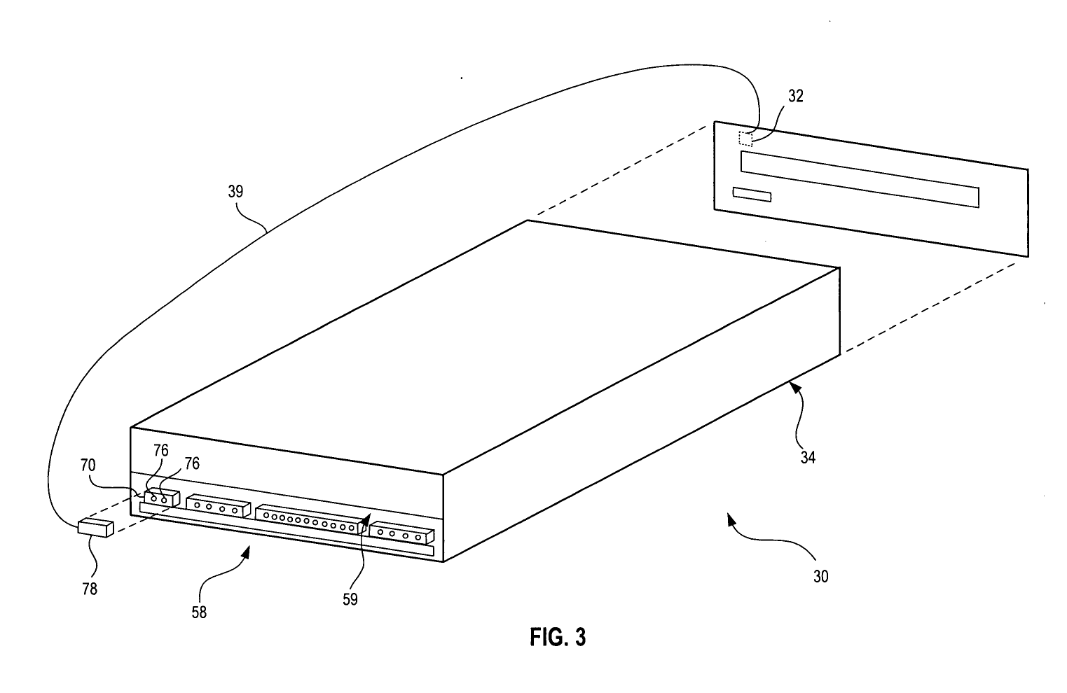

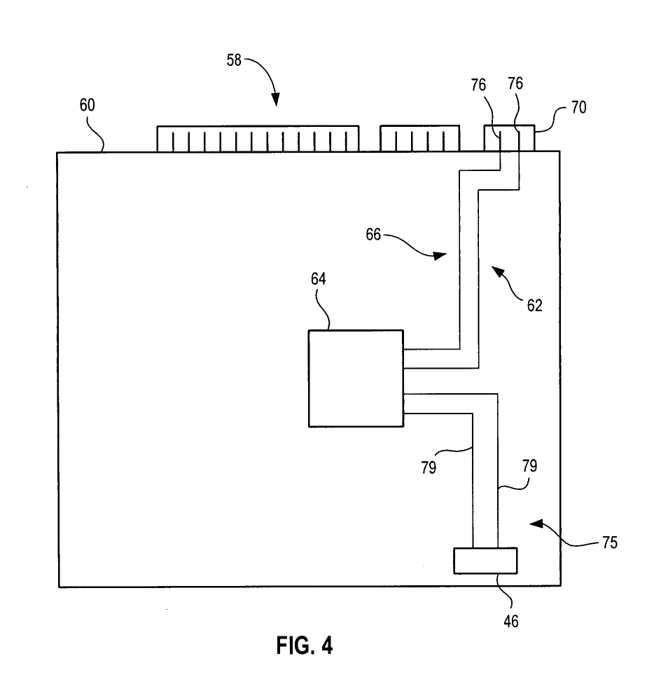

Still referring to FIG. 2, the circuitry of the circuit board 42 includes a controller (not shown in FIG. 3, but shown in FIG. 4 and discussed in greater detail in conjunction with FIG. 4) to execute programming instructions, and an input circuit (also not shown in FIG. 3 but shown in FIG. 4 and discussed in greater detail in conjunction with FIG. 4) to provide a signal to the controller that has been generated by the switch 32. The circuitry also includes a second switch 46 that instructs the motor to move the compact disc 36 into or out of the interior 40 when one exerts pressure on the switch 46. The second switch 46 is mounted to the circuit board 42 and is similar to the switch 16 (FIG. 1) in the conventional storage device 10 (FIG. 1). Thus, the switch 46 also may be used to insert the compact disc 36 from the device 30. In conventional storage devices that have the switch 32 added to them, the switch 46 could continue to provide its designed function. In storage devices that are designed and made to include the switch 32, the switch 46 may or may not be included in the devices.

Still referring to FIG. 2, the switch 32 is mounted to the housing 34 outside the interior 40 using conventional techniques. For example, in one embodiment the switch 32 is mounted to a cover plate 48 of the housing 34. The cover plate 48 is conventionally mounted to one or more walls 38 of the housing 34 to cover an opening of the housing 34 and protect the laser, circuit board 42, circuitry, tray 44, motor and other components of the device 30 disposed in the interior 40. The cover plate 48 includes a button 50 to allow one to exert pressure on the switch 46, and an opening 52 that the tray 44 extends through when the motor moves the tray 44 into and out of the interior 40. To allow one to easily see and reach the switch 32 when the tray 44 is extended through the opening 52, the switch 32 is mounted above the opening 52. Thus, one can more easily avoid damaging the device 30 when one inserts the compact disc 36 into the interior 40.

Still referring to FIG. 2, the switch 32 may be any conventional switch that generates a signal when a component (not shown) of the switch 32 is moved. For example, in one embodiment the switch 32 generates an electrical signal by completing and electrical circuit. The switch 32 includes a body 54 and a component 56 that extends away from the body 54. Pushing the component 56 toward the body 54 closes the switch 32, thus allowing an electrical signal to travel through the switch and through an input circuit of the circuitry. The controller then receives the signal and executes one or more instructions that are associated with the signal, which include generating a signal that directs the motor to move the tray 44 into or out of the interior 40.

FIG. 3 is a perspective view of the storage device 30 in FIG. 2 showing an interface 58 of the circuitry. The interface 58 is disposed in a second opening 59 of the housing 34 and allows one to connect a component disposed outside the housing 34 to the circuitry (not shown in FIG. 3) of the device 30 disposed in the interior 40 (FIG. 2). FIG. 4 is a schematic diagram of the circuitry 60 in the device 30 in FIG. 2 that includes an input circuit 62, according to an embodiment of the invention. The input circuit 62 connects the interface 58 to the controller 64 to allow the controller 64 to receive a signal generated by a component disposed outside the device's housing 34.

For example, in one embodiment the input circuit 62 includes a circuit 66 that typically exists on conventional storage devices and includes a connector 70 in the interface 58. The circuit 66 is typically designed to provide a signal that is generated by the controller 64 to a component that is connected to the connector 70. However, the controller 64 may be programmed to receive a signal through the circuit 66. For example, the switch 32 may be connected to the connector 70 and the circuit 66 may provide the controller 64 the signal generated by the switch 32. The connector 70 is a conventional connector that includes two pins 76. The cable 39 includes a conventional connector 78 that has two receptacles (not shown) each sized to receive a respective one of the pins 76. When the pins 76 are inserted into the receptacles, cable 39 is connected to the input circuit 62 and the controller 64 can receive a signal generated by the switch 32. Thus, the switch 32 may be easily added to a conventional storage device that was originally designed to include only the second switch 46.

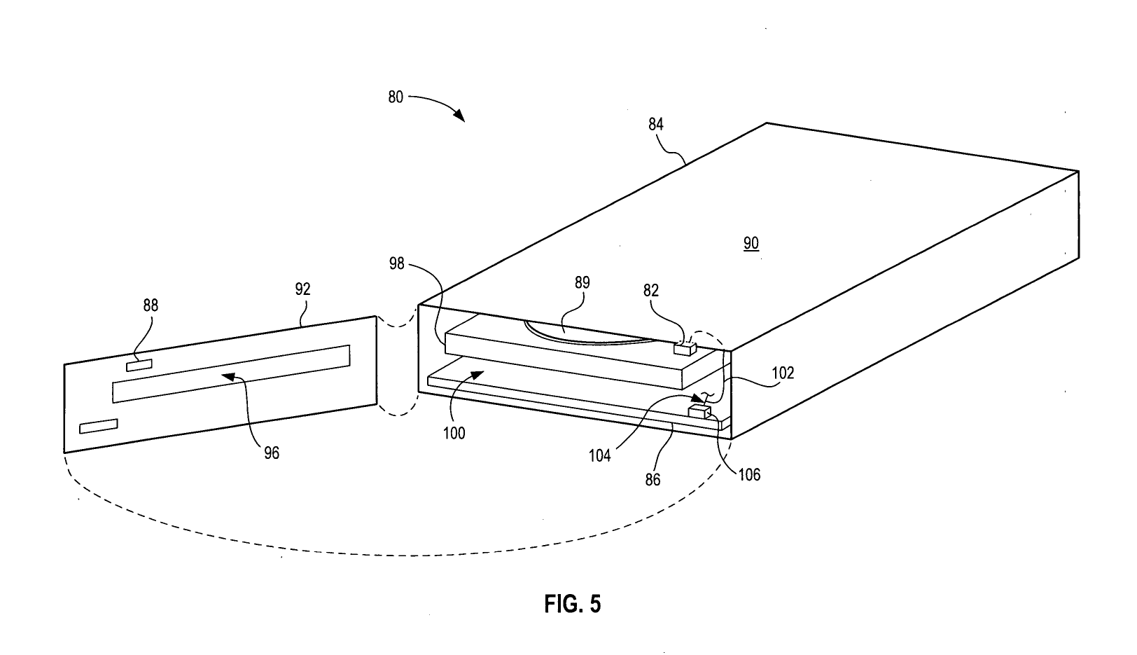

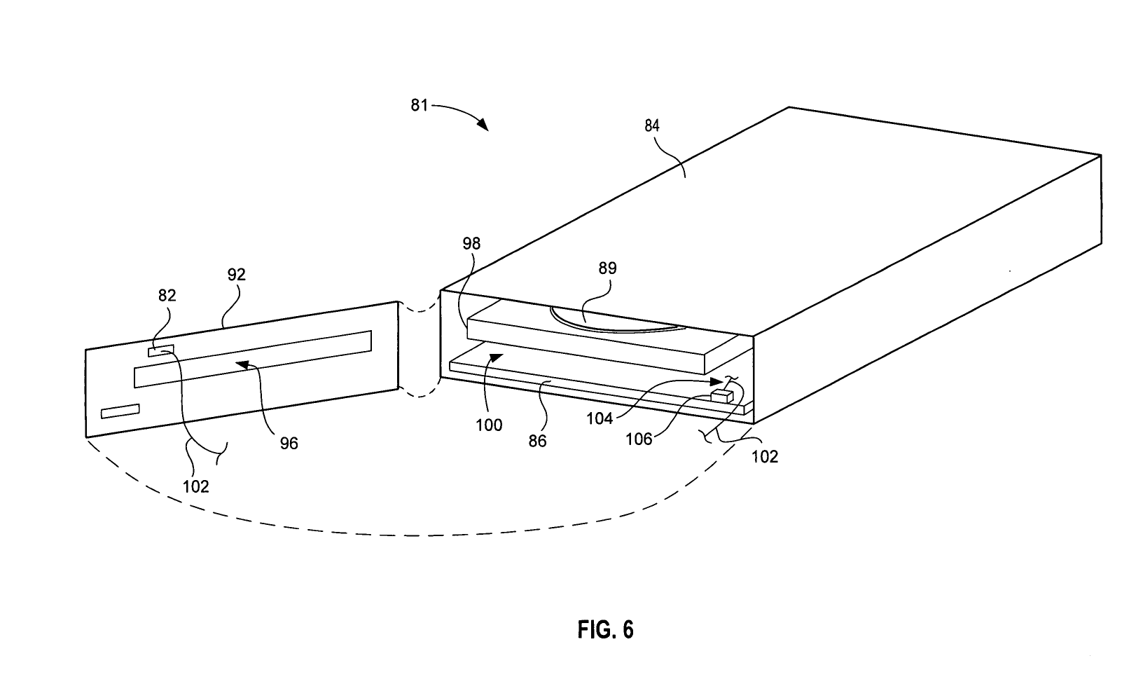

Other embodiments are contemplated. For example, the input circuit 62 may include another circuit 75 that connects the second switch 46 to the controller 64 (see FIGS. 5 and 6 and their related discussions). To connect the cable 39 (FIG. 3) to the circuit 75, the cable 39 may be soldered directly to the leads 79 or connected directly to leads 79 using any conventional technique. For another example, the input circuit 62 may include another connector (not shown) that is typically included in the interface 58 and that is connected to the controller 64. Or, the input circuit 62 may include another connector (not shown) that is solely dedicated to the input circuit 62 and separate from the circuit 66. Or, the input circuit 62 may be an additional circuit (not shown) in the device 30 that is solely dedicated to connecting a connector (not shown) of the interface 58 to the controller 64.

FIGS. 5 and 6 are perspective views of a storage device 80 (FIG. 5) and 81 (FIG. 6) that includes a switch 82 disposed inside the housing 84, according to other embodiments of the invention. Although the switch 82 is disposed inside the housing 84, the switch 82 is not mounted to a circuit board 86 of the devices 80 and 81. Thus, the switch 82 may be located where it can be easily contacted by a button 88 (FIG. 5) that is mounted on the housing 84 and that is located where it will be easier to see and reach. Thus, one can more easily avoid damaging the devices 80 and 81 when one inserts and removes a compact disc 89 from the devices 80 and 81.

For example, in one embodiment of the device 80 that is shown in FIG. 5, the switch 82 is located above the tray 88 and mounted to the wall 90 of the housing 84 using conventional techniques. The housing 84 includes a cover plate 92 that has a button 88 to allow one to exert pressure on the switch 82, and an opening 96 that the tray 98 extends through when the motor moves the tray 98 into and out of the interior 100. The cable 102 is soldered to the input circuit 104 that connects the second switch 106 to the controller (not shown) to connect the switch 82 to the controller. By mounting the switch 82 above the tray 98, one can easily see and reach the corresponding button 88 when the tray 98 is extended through the opening 96. Thus, one can more easily avoid damaging the device 80 when one inserts the compact disc 89 into the interior 100.

For another example, in one embodiment that is shown in FIG. 6, the switch 82 is located above the tray 98 and mounted to the cover plate 92 using conventional techniques. The cable 102 is soldered to the input circuit 104 of the second switch 106 that connects the second switch 106 to the controller (not shown) to connect the switch 82 to the controller.

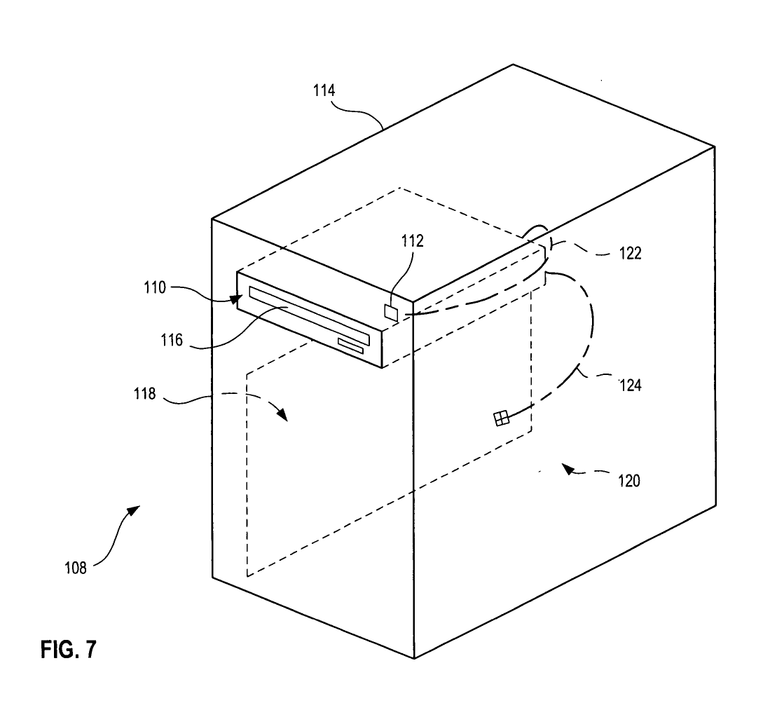

FIG. 7 is a perspective view of a system 108, for example a personal computer, that includes a storage device 110, according to an embodiment of the invention. The storage device 110 is similar to the storage device 30 of FIG. 2 except the switch 112 is mounted to the casing 114 of the system 108 using conventional techniques; not the housing 34 (FIG. 2) of the device 30 (FIG. 2). With the switch 112 mounted to the casing 114, the switch 112 may be located where it will be easy to see and reach when the tray 116 is moved out of the interior (not shown) of the device 110. Thus, one can more easily avoid damaging the device 110 when one inserts and removes compact discs (36 in FIG. 2) from the device 110.

For example, in one embodiment the system 108 includes a processing unit 118 for processing data read by the device 110. The system 108 also includes a casing 114 that defines an interior 120 in which the device 110 and the processing unit 118 are disposed, and that protects the device 110 and processing unit 118. The cable 122 connects the switch 112 to the circuitry (not shown) of the device 110 via an interface (not shown) of the device 110, and is also disposed in the interior 120. The cable 124 connects the device 110 to the processing unit 118 to allow the processing unit 118 to receive signals generated by the device 110.

Many of the specific details of certain embodiments of the invention are set forth in the above description and accompanying figures to provide a thorough understanding of such embodiments. One skilled in the art will understand, however, that the present invention may be practiced without some of the details described with regard to these embodiments. Moreover, one skilled in the art will understand that the figures related to the various embodiments are not to be interpreted as conveying any specific or relative physical dimensions, and that specific or relative physical dimensions, if stated, are not to be considered limiting unless the claims expressly state otherwise. Further, illustrations of the various embodiments when presented by way of illustrative examples are intended only to further illustrate certain details of the various embodiments, and shall not be interpreted as limiting the scope of the invention.

What is claimed is:

1. An electronic device for reading data from a removable storage medium, the device comprising:
circuitry operable to read data from a removable storage medium;
a housing operable to protect the circuitry and having a plurality of sides that define an interior in which the circuitry is disposed; and
a switch connected to the circuitry and disposed outside the housing, the switch being operable to generate a signal that the circuitry receives.

2. The device of claim 1 wherein the device includes an optical disk drive.

3. The device of claim 1 wherein the signal generated by the switch includes an electronic signal.

4. The device of claim 1 wherein the switch is operable to insert a storage medium into the interior of the housing.

5. The device of claim 1 wherein:
the housing includes a cover panel operable to cover an opening through which the interior is accessible, and
the switch is mounted to the cover panel.

6. The device of claim 1:
wherein the housing includes a cover panel operable to cover an opening in the housing;
further comprising a tray operable to move the storage medium through the opening; and
wherein the switch is mounted to the cover panel above the tray.

7. The device of claim 1:
further comprising a cable connected to the switch and including a first connector;
wherein the housing includes a second opening; and
wherein the circuitry includes an interface disposed in the second opening and having a second connector operable to receive the first connector to connect the cable to the circuitry.

8. The device of claim 1:
wherein the circuitry includes a controller operable to execute instructions and an input circuit operable to carry a signal toward the controller; and
further comprising a second switch connected to the input circuit and disposed in the interior of the housing, the second switch being operable to generate a signal that the circuitry receives.

9. An electronic device for reading data from a removable storage medium, the device comprising:
a circuit board including circuitry operable to read data from a removable storage medium;
a housing operable to protect the circuit board and having a plurality of sides that define an interior in which the circuit board is disposed; and
a switch connected to the circuit board and disposed in the interior but not mounted to the circuit board, the switch being operable to generate a signal that the circuitry receives.

10. The device of claim 9 wherein the switch is operable to insert a storage medium into the interior of the housing.

11. The device of claim 9 wherein the switch is mounted to a side of the plurality of sides.

12. The device of claim 9 wherein:
the housing includes a cover panel operable to cover an opening through which the interior is accessible, and
the switch is mounted to the cover panel.

13. The device of claim 9 wherein:
the circuitry includes a controller operable to execute instructions, an input circuit operable to carry a signal toward the controller, and
the switch is connected to the input circuit.

14. The device of claim 9:
wherein the circuitry includes a controller operable to execute instructions and an input circuit operable to carry a signal toward the controller; and
further comprising a second switch connected to the input circuit and mounted to the circuit board, the second switch being operable to generate a signal that the circuitry receives.

15. An electronic system comprising:
an electronic device for reading data from a removable storage medium, the device comprising:
circuitry operable to read data from a removable storage medium;
a housing operable to protect the circuitry and having a plurality of sides that define an interior in which the circuitry is disposed; and
a switch connected to the circuitry and disposed outside the housing, the switch being operable to generate a signal that the circuitry receives; and
a processing unit coupled to the device and operable to process the data read by the device.

16. The system of claim 15 wherein the system includes a personal computer.

17. The system of claim 15:
further comprising a casing having an interior in which the processing unit is disposed and the electronic device is disposed; and
wherein the switch is mounted to the casing.

18. An electronic system comprising:
an electronic device for reading data from a removable storage medium, the device comprising:
a circuit board including circuitry operable to read data from a removable storage medium;
a housing operable to protect the circuit board and having a plurality of sides that define an interior in which the circuit board is disposed;
a switch coupled to the circuit board and located in the interior but not mounted to the circuit board, the switch being operable to generate a signal that the circuitry receives; and
a processing unit coupled to the device and operable to process the data read by the device.

19. A method for removing a storage medium from an electronic device, the method comprising:
locating a switch outside a housing of the device;
connecting the switch to circuitry disposed inside the housing; and
exerting pressure on the switch to generate a signal.

20. The method of claim 19 wherein locating the switch outside the housing includes mounting the switch to a cover plate of the housing.

21. The method of claim 19:
further comprising moving a tray of the device to carry the storage medium out of the housing; and
wherein locating the switch outside the housing includes mounting the switch to a cover plate of the housing and above the tray.

22. The method of claim 19 wherein connecting the switch to the circuitry includes connecting a cable to an interface of the circuitry.

23. The method of claim 19 wherein exerting pressure on the switch includes pushing a component of the switch to close the switch.

24. A method for removing a storage medium from an electronic device, the method comprising:
locating a switch inside a housing of the device but not mounting the switch to a circuit board disposed inside the housing;
connecting the switch to circuitry of the circuit board;
exerting pressure on the switch to generate a signal.

25. The method of claim 24 wherein locating the switch inside the housing includes mounting the switch to a side of the housing.

26. The method of claim 24 wherein locating the switch inside the housing includes mounting the switch to a cover plate of the housing.

27. The method of claim 24:
further comprising moving a tray of the device to carry the storage medium out of the housing; and
wherein locating the switch inside the housing includes mounting the switch to a cover plate of the housing and above the tray.
